(19) United States
(12) Patent Application Publication
(10) Pub. No.: US 2025/0198142 A1
(43) Pub. Date: Jun. 19, 2025

(54) INSERT PART FOR A JET REGULATOR, AND ASSOCIATED PRODUCTION METHOD

(71) Applicant: Neoperl GmbH, Müllheim (DE)

(72) Inventors: Mathias REHM, Buggingen (DE); Marc TEMPEL, Freiburg (DE)

(73) Assignee: Neoperl GmbH, Müllheim (DE)

(21) Appl. No.: 18/847,728

(22) PCT Filed: Mar. 21, 2023
(86) PCT No.: PCT/EP2023/057203

§ 371 Date: Sep. 17, 2024

(30) Foreign Application Priority Data
Mar. 23, 2022 (DE) 20 2022 101 528.7

(51) Int. Cl. E03C 1/086; B29C 45/00; B29C 45/26; B29L 31/00

(52) U.S. Cl. CPC E03C 1/086; B29C 45/26; B29C 2045/0034; B29L 2031/737

(57) ABSTRACT

In order to simplify the manufacture of an insert part, which has two web structures, each of which forms a plurality of webs, it is proposed that the insert part is manufactured by a molding process in such a way that the two web structures touch each other in respective contact surfaces, but nevertheless remain separated from each other by a mold parting plane. This has the technical advantage that the respective outer contour of the webs of the respective web structure can be defined exclusively with a respective mold part without an offset of the respective other mold part having a negative effect on the shaping of the webs.

### CROSS-REFERENCE TO RELATED APPLICATIONS

This application is a 371 National Phase of PCT/EP2023/057203, filed Mar. 21, 2023, which claims priority to German Patent Application No. 20 2022 101 528.7, filed Mar. 23, 2022, both of which are incorporated herein by reference as if fully set forth.

### TECHNICAL FIELD

The invention relates firstly to an insert part which can be designed in particular for insertion into a receiving chamber of a jet regulator, wherein water can flow through the insert part along a flow direction. Such an insert part can be used in multiple applications and fluidic devices to favorably influence the flow behavior of a fluid.

The invention also relates to a jet regulator with a splitter unit and an outlet unit and a receiving chamber formed therebetween, which is surrounded by a housing (and in particular can be formed by the housing), wherein at least one insert part through which water can flow is inserted in the receiving chamber.

Finally, the invention relates to a method by which such inserts can be manufactured.

### BACKGROUND

Such insert parts and jet regulators are already known. The aforementioned splitter unit often forms an inlet or splitter stage and can split a water cross-section flowing into the jet regulator into numerous partial water jets. This results in a kind of “reset” of the flow conditions within the jet regulator, which thus become largely independent of the flow characteristics in the area of an inlet on the inlet side of the jet regulator. For this purpose, the jet regulator can also have a flow regulator or flow limiter, for example. The outlet unit or outlet stage finally forms the jet that emerges from the jet regulator. An admixture of air can be formed in the jet regulator to produce a soft, milky, cloudy jet.

The insert part arranged between the outlet unit and the splitter unit in the receiving chamber makes it possible to further influence the jet formation in a favorable way. The insert part often takes on the function of a fluidic mixing stage, which further homogenizes the jet. This can have a particularly positive effect on the flow behavior.

It is also known to manufacture the individual components of such jet regulators using injection molding technology, for example as described in WO 2021 123065 A1.

In practice, however, this often results in the problem that undesirable sharp edges can occur, as the injection molds used cannot be aligned precisely as required. If the molds are slightly misaligned, this often results in the formation of fine molding fins (especially if the liquid plastic penetrates into small gaps) and sharp edges. Such structures can then have a negative effect on the spray pattern produced by the jet regulator or the noise generated when water flows through the jet regulator. This is particularly troublesome when long edges with a precise profile have to be formed. In particular, it is known that molding fins can form in the mold parting line when the injection molding material is pressed between the mold parts.

### SUMMARY

The invention aims to eliminate this problem that occurs during production. To solve this object, one or more of the features disclosed herein are provided for an insert part according to the invention. In particular, it is thus proposed according to the invention for solving the problem in an insert part of the type mentioned at the beginning that the insert part is composed of two web structures which are arranged in two superimposed planes and which each have a plurality of webs. It is further provided that the two web structures are each separated from one another by a mold parting plane. Each of the two web structures can therefore be completely located in a respective half-space, which is separated by the mold parting plane (the two half-spaces are therefore opposite each other). These two half-spaces can touch each other, namely in the mold parting line, but do not show any overlap or overlap volume.

The mold parting plane can correspond to an imaginary mathematical plane that is flat (i.e. has a curvature of zero in relation to two orthogonal axes that lie in the plane).

In other words, according to the invention, the respective web structure, more precisely the outer edges and side surfaces of the respective webs of the web structure, can in each case only be defined or have been defined by means of a part of a mold (in particular a mold half) used during molding of the insert part. Therefore, the respective part of the mold must also only have recesses for the webs of one of the two web structures. If the two parts of the mold are joined together to form a cavity that defines the insert part to be cast, they meet at the mold parting line.

Accordingly, an offset of a first mold half, as described at the beginning, which serves to define a first of the two web structures, along the mold parting plane has precisely no effect on the shaping of the second web structure of the insert part. This significantly improves or simplifies the manufacture of the insert part.

The two planes in which the web structures are arranged can, in particular, extend parallel to the mold parting plane. Due to the separation caused by the mold parting plane, it can be achieved in particular that the respective webs of the two web structures do not interlock, but only touch each other in contact surfaces that lie in the mold parting plane. These contact surfaces can be formed by the respective overlaps between webs of the two neighboring web structures of the insert part. In particular, the insert part can be designed in such a way that the webs of one of the web structures form respective contact surfaces but no overlapping volume with webs of the neighboring web structure.

The design of the insert part according to the invention prevents the web structure which lies in the upper plane from merging into the web structure which lies in the lower plane along a longer edge, because this would lead to the formation of undesirable edge shapes, in particular to the formation of molding fins, if the two mold halves which are used for injection molding the insert part are misaligned relative to one another, i.e. show an (often unavoidable) offset. This problem no longer exists, particularly if the webs of the contacting web structures are angled, as an offset between the mold halves no longer has any significant effect on the formation of the edges of the webs, as the contact surfaces between the two web structures may shift (minimally), but only change insignificantly in size. This means that a usable insert can still be injection molded even if the two halves of the mold are slightly offset. As a result, rejects can be avoided during the production of the insert part.

As will be explained, insert parts according to the invention can be used to regulate the water flow in jet regulators. However, they can also be used, for example, in other fluid-flowing line sections of fluidic, in particular sanitary, devices in order to positively influence the fluid flow, for example in order to achieve a reduction in noise. The invention is mainly concerned with how such structures can be manufactured efficiently and with as little waste as possible and how assembly can be simplified if several such (in particular identically designed) insert parts have to be assembled to form a stack arrangement.

According to the invention, the object mentioned at the beginning can also be solved by further advantageous embodiments described below and in the claims.

For example, the webs of the upper web structure can intersect with the webs of the lower web structure at contact surfaces. Furthermore, webs of the same web structure in particular can branch at branching points, wherein this can be realized for one or both of the two web structures.

Furthermore, designs are possible in which at contact points of the two web structures (i.e. where two webs of the two web structures meet) the respective webs extend at a crossing angle β to each other. The angle β can, for example, be a constant 90°, such as in a design in which the respective webs of the upper web structure extend strictly parallel to each other and each form an angle of 90° with the webs (also extending strictly parallel to each other) of the lower web structure. The angle can be measured by projecting the respective web into the mold parting plane.

Configurations are also conceivable, for example with curved webs, in which the angle β varies along the course of a web and in particular is sometimes less and sometimes more than 90°. For example, when using honeycomb-shaped free spaces between the webs, which can be designed in a triangular or hexagonal shape, there can be several points of contact with different angles β per honeycomb.

The crossing angle β can also be dimensioned such that a surface area of a respective contact surface of the intersecting webs (of the two web structures) in the mold parting plane is at most three times the square of a (e.g. maximum) width of the respective web, measured transversely to a running direction of the web.

Furthermore, designs are possible in which the following applies for the crossing angle β: β>20°. Preferably, the following can then also apply: β≤90°. With such designs, very small crossing angles β of the webs are therefore excluded. At β=45°, the ratio between the contact surface and the square of the web width is approximately 1.5, whereas at 20° the ratio increases to >3. The technical advantage of providing a certain minimum size for the crossing angle is that a small offset between the mold halves can still be tolerated during injection molding because the position of the crossing surface changes only insignificantly as a result. If, on the other hand, the webs extend at very small crossing angles to each other, the crossing area becomes very large and therefore susceptible to the formation of undesirable molding fins at the edges of the webs as a result of an offset between the mold halves.

In further embodiments, the angle β can, at least partially, be less than 90° or equal to 90°. It may also be provided that the angle β at individual points of contact is (additionally or complementarily) more than 90°.

The at least two web structures of the insert part can preferably be connected or formed in one piece. This is possible in particular if the insert part is manufactured as a cast part, preferably as an injection molded part. Such production can be carried out in particular using two mold parts, especially two injection mold halves, which meet in the mold parting plane. In such cases, it is particularly advantageous if the two web structures are free of undercuts along a demolding direction that is perpendicular to the mold parting plane. This design has the advantage that each of the two web structures can be finished with one mold half each of a (common) injection mold.

According to a further possible design, it is provided that the insert part has at least one web structure whose webs extend, at least partially, non-parallel to one another, i.e. in particular at angles of less than 90°. In this case, branching points can thus be formed between webs of the same web structure.

According to a further possible design, it is provided that at least one of the two web structures has webs which have an S-shaped course in the said plane. Such an S-shaped course can in particular have two inflection points.

In particular, it may therefore be provided that the two web structures that make up the insert part form different types of intermediate web spaces. For example, one web structure can form elongated slots in an upper plane, while the neighboring web structure forms honeycomb-shaped free spaces in a lower plane.

The said mold parting plane can be understood as an xy-plane and this can divide the insert part into the two web structures.

If the two web structures are designed in the same way, it can be provided that the two web structures of the insert part are designed symmetrically to each other in relation to the mold parting plane, in particular strictly.

For example, the two web structures can be formed symmetrically to each other in such a way that the two web structures can be transferred into each other by an (imaginary) rotation through 180° about an x-axis lying in the mold parting plane and (i) by rotation through an angle q about a z-axis aligned perpendicular to the mold parting plane and/or by displacement along a y-axis lying in the mold parting plane and/or along an x-axis lying in the mold parting plane. In other words, the same situation is thus obtained with respect to the position of the passage channels formed by the insert part if the insert part thus designed is first rotated by 180° about the x-axis (“flipping”) and then one or both of the operations (i) or (ii) are carried out. The symmetry described is thus based on an isometric transformation of the respective web structure, which preserves the lengths and angles of the web structure, i.e. in such a symmetrical design, the length and angle ratios of the two web structures of the insert part can be identically formed. An advantage of such symmetrical designs of the insert part is, for example, that it does not matter in which orientation the insert parts are assembled to form a stack arrangement. This is because if the insert part in question was inserted in the wrong orientation (=rotation by 180° around the x-axis), a corresponding rotation by o around the z-axis may already be sufficient to achieve the desired alignment of the web structure.

In the design described above, it may preferably be provided that the angle φ=360°/N is formed as an integer division of 360°, i.e. in particular with φ=90° or φ=120° or even φ=60°.

It may further be provided that the two (imaginary) planes (which describe the position of the web structures) are each aligned radially or perpendicularly with respect to an axial insertion direction of the insert part or the aforementioned flow direction in which water can flow through the insert part. The axial insertion direction can just correspond to the main flow direction in which the water flows through a jet regulator comprising the insert part, in particular through said insert part. Furthermore, all web surfaces of the webs of each web structure that are aligned with the mold parting plane (i.e. facing “inwards”) can lie in a respective radial plane in relation to the insertion direction/the flow direction of the insert part. To solve the problem with the molding fins, it is advantageous if these web surfaces are planar and lie in the mold parting line. This is because in this case, these web surfaces can be limited during injection molding by a planar, inner surface of the corresponding mold half of the injection mold.

At least one, in particular both, of the web structures can also form intermediate web spaces arranged between the webs in the form of honeycombs. In particular, these honeycombs can have a hexagonal shape or a triangular shape. In such a design, a plurality of such honeycomb-shaped intermediate web spaces can also line up along an (imaginary) secant with respect to a circumference of the web structure (to form a chain). The honeycombs can be separated from each other by respective webs. Such designs make it possible in particular for an adjacent web structure, especially of the same insert part or of an adjacent insert part (if several insert parts are used in a stack arrangement), to form intermediate web spaces in the form of slots. These slots can extend as a secant to the respective circumference of the web structure.

The said honeycomb-shaped intermediate web spaces can be of a constant size and shape. However, organic or ornamental web structures can also be designed in which the individual intermediate web spaces differ in their respective shape and/or size.

According to a further design, the respective webs of the two web structures can each form lateral surfaces which are aligned axially in an insertion direction of the insert part (which can coincide with said flow direction) and which extend coaxially to one another.

It can therefore also be provided that passage channels are formed by intermediate web spaces which exist between the webs, are aligned in the insertion direction/flow direction and are delimited by the webs. In this case, it is particularly preferable if the webs of the two web structures of the respective insert part are arranged relative to one another in such a way that the passage channels extend in a straight line and/or without twists in the insertion direction/flow direction.

For smooth demolding of the insert part, for example after injection molding, it is also advantageous if both web structures each have cross-sections everywhere that point away from the mold parting plane and these cross-sections do not increase (in the direction pointing away from the mold parting plane). In other words, the cross-sections can (starting from the mold parting plane) in particular form constant or tapering cross-sections, again everywhere.

To solve the object, a jet regulator as described at the beginning is also proposed. This is characterized in that the at least one insert part is designed according to one or more of the features disclosed herein directed to an insert part and/or as described above.

In the receiving chamber, at least two insert parts designed according to the invention can preferably be arranged one above the other in a stack arrangement in an axial insertion direction. This insertion direction can extend perpendicular to the said (radially aligned) mold parting plane and/or correspond to the said flow direction of a water flow through the at least one insert part.

It is particularly preferable if the at least two insert parts are of the same type or identical to each other. In addition or alternatively, it may also be provided that the at least two insert parts are arranged rotated relative to each other by an angle α around the insertion direction. For example, the following may apply: α=φ/2, where φ is the angle that describes the relative rotation of the two web structures of the insert part after one of the two web structures has been theoretically flipped/rotated by 180° about an axis lying in the mold parting plane. In particular, the following can apply: α=45° with φ=90° or, for example, α=60° with φ=120°.

Such a design has the advantage that when stacking a total of three (in particular identically designed/produced with the same injection mold) insert parts on top of each other, the sequence and orientation of the insert parts is irrelevant, as the desired pattern of passage channels can always be formed (by corresponding rotation of the insert part around the z-axis).

In such designs of the jet regulator, the receiving chamber can therefore be traversed exclusively by passage channels formed by the at least one insert part when the insert part(s) is/are inserted. In this case, the insert part or the stack arrangement defines the flow behavior of the receiving chamber.

When using multiple insert parts in a stack arrangement, passage channels aligned axially in the insertion direction, which are formed by one of the insert parts, can be at least partially concealed by a web structure of an adjacent insert part of the stack arrangement (with respect to the insertion direction). This is advantageous in order to enable an even finer subdivision of the water flow through the receiving chamber. In particular, these covers can be formed by a respective branching point of two webs of one of the web structures (of a neighboring insert part).

The passage channels aligned axially in the insertion direction, which are formed by one of the insert parts, can also meet a contact point of the two web structures of an adjacent insert part of the stack arrangement in the stack arrangement. This is particularly possible if these web structures do not form any branching points, for example because all the webs of the respective web structure extend strictly parallel to each other.

In such designs, a cross-sectional area taken up by a respective passage channel can therefore—in relation to the entire stack arrangement—not be completely traversed by water in the axial direction. This means that a flow cross-section (in relation to an axial direction and the entire stack) is specified which is smaller than the respective passage channel specified by one of the insert parts. For clarification, it should also be mentioned at this point that the area of the respective passage channel can be smaller than a respective intermediate web space defined by one of the two web structures of the insert part.

In such designs, at least part of the water can thus inevitably follow a zigzag course when flowing through the stack arrangement and thus deviate from a strictly axial flow direction. In other words, in such a design, the passage channels of two adjacent insert parts of the stack arrangement do not have to be aligned, but can be arranged offset to each other so that they do not completely overlap.

A particularly preferred design provides for the at least two insert parts to be aligned with each other with respect to a relative angle of rotation a about the insertion direction by means of respective alignment aids which engage with each other in the insertion direction. This angle of rotation a can in particular be the angle α described above. It is particularly easy for the respective alignment aids to be formed in one piece with the respective web structure, for example in the form of axial and corresponding projections and recesses.

It is even more advantageous if upper and lower alignment aids are formed on at least one of the insert parts, which are aligned with each other in relation to an insertion direction. This makes it easier to assemble the stack arrangement if an insert part is inadvertently inserted in the wrong orientation (rotation by 180° around the x-axis).

For example, at least four, in particular at least six, alignment aids can be formed along a circumference of one (preferably all) of the at least two insert parts. These alignment aids can face axially in the same direction. Furthermore, they can be evenly distributed along the circumference. In particular, this can ensure that the said relative angle of rotation a is at most 45°, in particular at most 30°.

An injection point used during injection molding of the respective insert part can, for example, be arranged in the center of the insert part or, for example, on the edge, in particular on the circumference.

A particularly preferred design, which reduces manufacturing costs, provides that each of the at least two insert parts of the stack arrangement can be arranged or is arranged with an identical copy of itself in the compact stack arrangement. In this stack arrangement, a lower axial profile of the insert part can engage in an upper axial profile of the (identical) insert part. This means that in such a stack arrangement, the two identical insert parts used can be arranged rotated relative to each other by an angle α about an insertion direction.

This means that the at least two insert parts can in particular all be shaped/designed identically to each other, i.e. in other words they can be manufactured with the same two injection mold halves. The insertion direction can then correspond precisely to the direction in which two identical insert parts (after rotation by the angle α) can be brought together to form a compact stack of two.

To solve the object, a method for manufacturing an insert part is also proposed, wherein this insert part can be designed as described above or having one or more of the features disclosed herein directed to an insert part. The insert part can thus be provided in particular for insertion into a receiving chamber of a jet regulator. The method provides that the insert part is produced as a cast part, in particular by injection molding, and is further characterized in that the insert part is composed of two web structures which are arranged in two superimposed planes and which each form a plurality of webs, and in that a first mold part is used to form a first of the two web structures during molding, while a second of the two web structures is formed only with a second mold part during molding.

Although the first mold part can help define the mold parting plane and thus also limit the second web structure defined by the second mold part, the shape of the webs, in particular their (preferably axially aligned) side surfaces, is only defined by the second mold part. Accordingly, an offset of the first mold half along the mold parting plane has precisely no effect on the shaping of the second web structure of the insert part with the aid of the second mold half.

The two mold parts can thus preferably be designed as mold halves of an injection mold. During the molding process, the two mold halves are joined together along the mold parting plane to form a cavity that defines the outer contour of the insert part produced as a cast part, in particular as an injection molded part. Once liquid molding material has been introduced into the cavity and the molding material has hardened, the mold halves can be separated from each other again (which can typically be done perpendicular to the mold parting plane, i.e. along the demolding direction described above) so that the finished insert can be removed from the cavity as a cast part. As already explained at the beginning, the invention avoids the formation of undesired molding fins during the molding process and thus rejects during production due to the specific position of the mold parting plane and the described design of the production method.

### BRIEF DESCRIPTION OF THE DRAWINGS

The invention will now be described in more detail with reference to exemplary embodiments, but is not limited to these exemplary embodiments. Further configurations of the invention can be obtained from the following description of a preferred exemplary embodiment in conjunction with the general description, the claims and the drawings.

In the following description of various preferred embodiments of the invention, elements which correspond in their function are given corresponding reference numbers even if their design or shape differs, wherein:

FIG. 1 shows an external view of a jet regulator according to the invention,

FIG. 2 shows a cross-section through a further jet regulator according to the invention, wherein the jet regulator is screwed into a sanitary fitting,

FIG. 3 shows a cross-section through the jet regulator of FIG. 1,

FIG. 4 shows a cross-section through an insert part designed according to the invention,

FIG. 5 shows a stack arrangement consisting of three identically designed insert parts according to the invention,

FIG. 6 shows a top view of a further insert part according to the invention,

FIG. 7 shows the insert part of FIG. 6 in oblique view from above,

FIG. 8 shows a top view of the insert part in FIG. 6 from below,

FIG. 9 shows the insert part of FIG. 6 in oblique view from below,

FIG. 10 shows a further insert part designed in accordance with the invention,

FIG. 11 shows an exploded view of the jet regulator from FIG. 1,

FIG. 12 shows the stack arrangement 13 the three insert parts which are shown in FIG. 11,

FIG. 13 shows the stack arrangement of FIG. 12 in oblique view,

FIG. 14 shows different views of a further insert part according to the invention,

FIG. 15 shows different views of a further insert part designed according to the invention,

FIG. 16 shows different views of a further insert part designed in accordance with the invention,

FIG. 17 shows different views of an insert part designed according to the invention,

FIGS. 18-21 show in each case stack arrangements 13 consisting of three insert parts (each) designed according to the invention,

FIG. 22 shows a detailed view of the web structure of the insert part shown in FIG. 15,

FIG. 23 shows a detailed view of the insert part shown in FIG. 14,

FIG. 24 illustrates the formation of molding fins at edges of webs of a web structure,

FIG. 25 shows a detailed top view of the web structure of the insert part from FIG. 17,

FIG. 26 shows a detailed top view of the web structure of the insert part from FIG. 14,

FIG. 27 shows a detailed top view of the web structure of the insert part from FIG. 16,

FIG. 28 shows two mold parts in the form of two mold halves for manufacturing an insert part according to the invention by means of injection molding,

FIG. 29 shows the lower of the two mold halves illustrated in FIG. 28 in a perspective sectional view,

FIG. 30 shows a perspective cross-section through the mold half from FIG. 29 but with the insert still inserted, which was produced by injection molding with the two mold halves from FIG. 28,

FIG. 31 shows the same situation as in FIG. 30, only intersected at a slightly offset position,

FIG. 32 shows an insert part known from the prior art for use in a jet regulator, which has web structures not designed according to the invention,

FIG. 33 shows a longitudinal section through the upper mold half (cf. FIG. 28), analogous to FIG. 31 for the lower mold half, and finally

FIG. 34 shows a further longitudinal section through the upper mold half (cf. FIG. 28), analogous to FIG. 33, but intersected at a different decentralized location.

### DETAILED DESCRIPTION

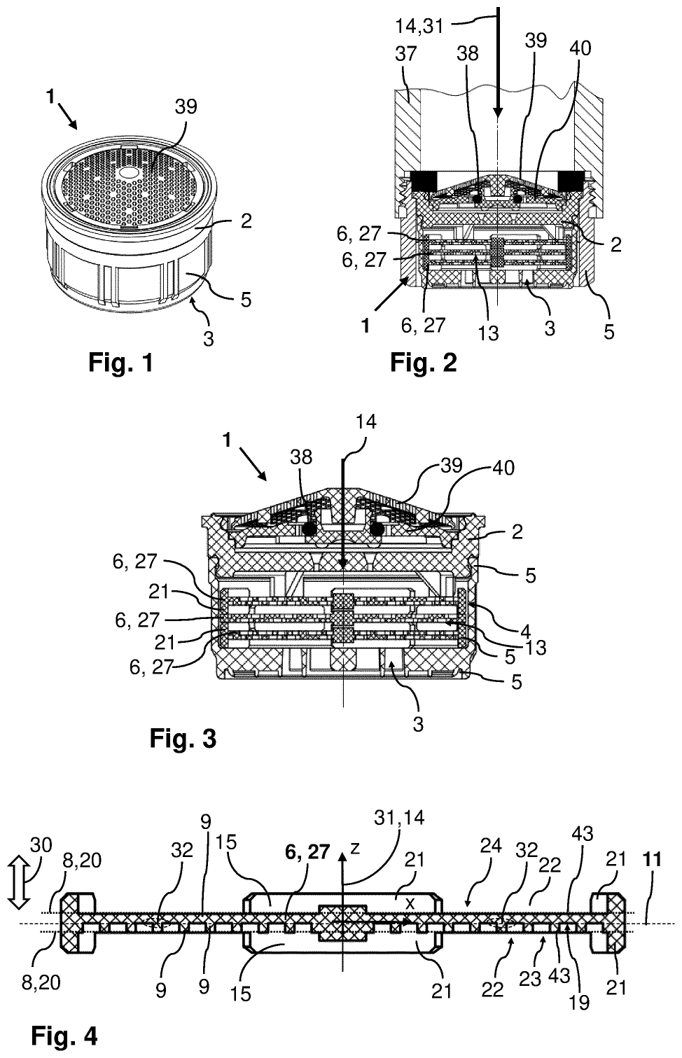

FIG. 1 shows a jet regulator 1 designed according to the invention, whose components can be seen in the cross-sectional view of the FIG. 3, wherein the outer housing 5 could also be designed as in FIG. 2 for example, so that the jet regulator 1, as shown in FIG. 2, can be screwed into a sanitary fitting 37. The jet regulators 1 of FIGS. 1-3 each have a splitter unit 2 and an outlet unit 3 and a receiving chamber 4 formed between them, which is surrounded by the housing 5 and is formed in the shown designs by the housing 5. In the receiving chamber 4 a total of three insert parts 6 designed according to the invention are arranged in a stack arrangement 13 one above the other, wherein water can flow through each of the three insert parts 6 in the flow direction 31 as shown in FIG. 2.

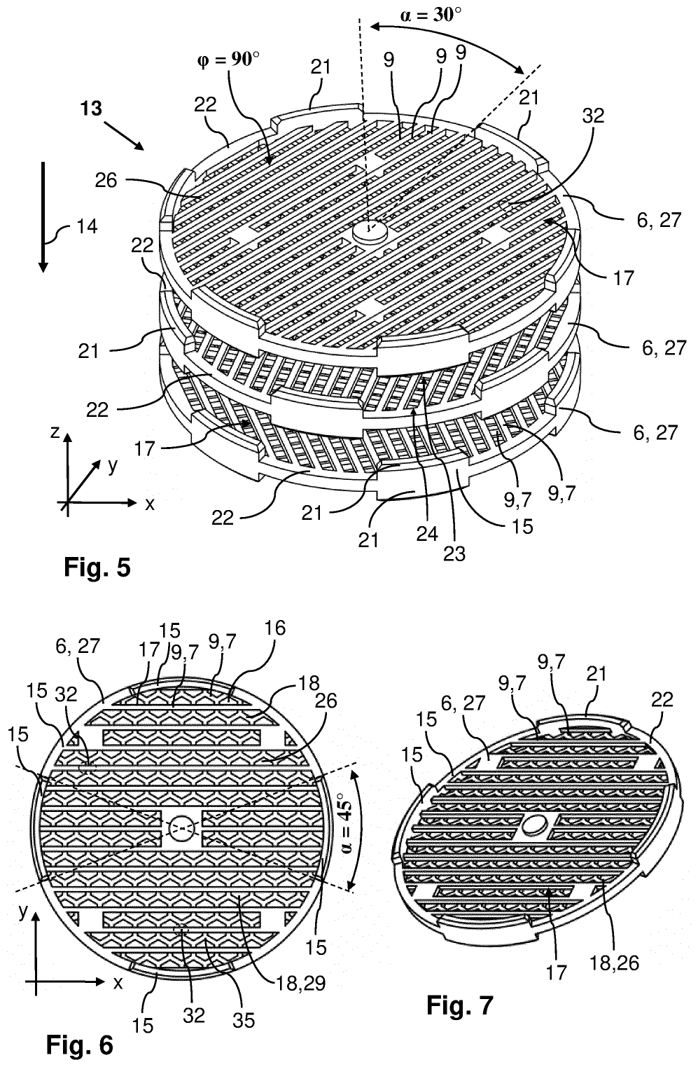

FIG. 4 shows by way of example the design of one of the insert parts 6 of the jet regulator 1 in a cross-sectional view. The centrally arranged and dashed drawn line 11 denotes a mold parting plane 11, which is used in the manufacture of the insert part 6 by means of injection molding and which divides the insert part 6 manufactured in one piece from a molding material into two halves. In each of these two halves (or half-spaces, separated by the mold parting plane 11) a respective web structure 7 is formed, which can be designed as illustrated in the FIGS. 5-17 for example.

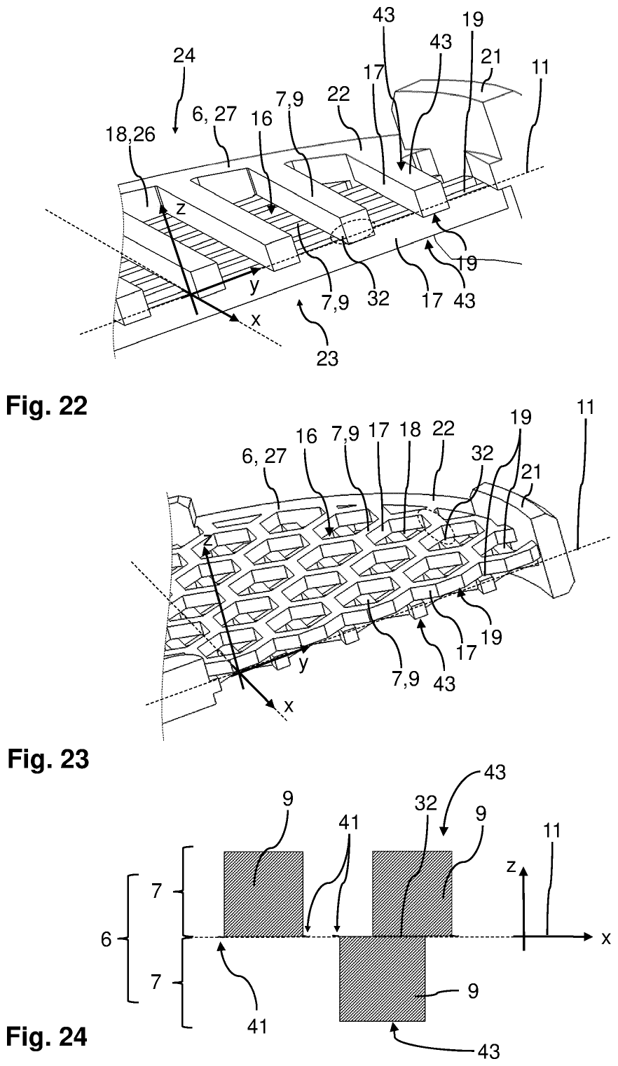

The insert part 6 is thus composed of the two web structures 7, which are arranged, as shown in FIG. 4, in two superimposed planes 8, each extending parallel to the mold parting plane 11. In this case, each of the two web structures 7 has a plurality of webs 9. However, since the webs 9 of the upper web structure 7 in FIG. 4 extend horizontally from left to right, only one of these webs 9 can be seen in cross-section for the upper web structure 7. The planes 8, in which the two web structures 7 are arranged, are each aligned radially or perpendicularly to the flow direction 31, as shown in FIG. 4. As a result, the respective web surfaces 19 of the webs 9, which are aligned inwards towards the mold parting plane 11, (also cf. FIGS. 22 and 23) lie in a respective radial plane 20 in relation to the flow direction 31 or the insertion direction 14.

FIG. 15, which shows further views of the insert part 6 of FIG. 4, clearly shows that the two web structures 7, each having a plurality of webs 9, are separated from each other by the (imaginary) mold parting plane 11. Contact surfaces 32 are thus formed between the two web structures 7 at those points at which the webs 9 of the upper web structure 7 intersect with the webs 9 of the lower web structure 7. However, as can be seen from the combined view of FIGS. 4 and 15, the web structures 7 do not overlap and therefore in particular do not form an overlapping volume.

FIGS. 6, 7, 8 and 9 and 14 and 17 show further examples of insert parts 6 designed according to the invention, which are each composed of two web structures 7. However, in these designs, the webs 9 of the same web structure 7 branch off at branching points 35. Furthermore, there are contact surfaces 32 between the two web structures 7. The said branching points 35 are thus formed in such a way that in each case at least one web structure 7 of the insert part 6 has webs 9, which do not extend parallel to each other (but at angles to each other) and thus meet at the branching points 35.

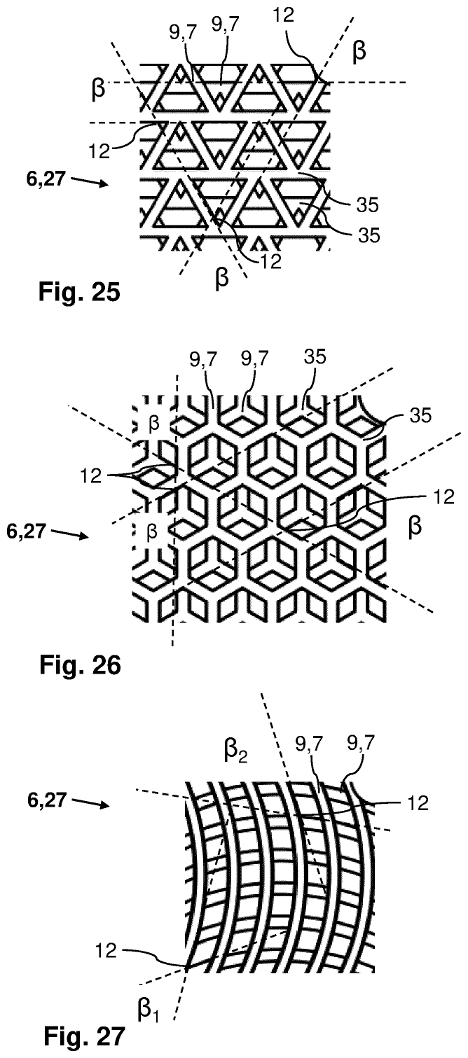

As can be seen from the detailed views of FIGS. 25-27, the respective webs of the two mutually adjacent web structures 7 of the respective insert part 6 extend there at the respective contact points 12 at a crossing angle β. In all these designs, the crossing angle β is just dimensioned such that a respective area defined by the respective contact surface 32 (wherein the contact surface 32 lies in the mold parting plane 11—see FIG. 4 in this respect—and defines the area at which webs 9 of two adjacent web structures 7 cross) is at most three times the square of a maximum width of the respective web 9. The width is measured transverse to the main direction of the web 9.

In addition, the crossing angle β>20° is designed in all of these designs; the examples in FIGS. 25-27 in particular also show crossing angles of β<90°.

The insert part 6 shown in FIG. 4 is manufactured as an injection-molded part 27, like all insert parts 6 in the other figures. Therefore, the two web structures 7 are integrally connected or monolithically formed, as can be seen in particular from the hatching in the cross-sectional view of FIG. 4.

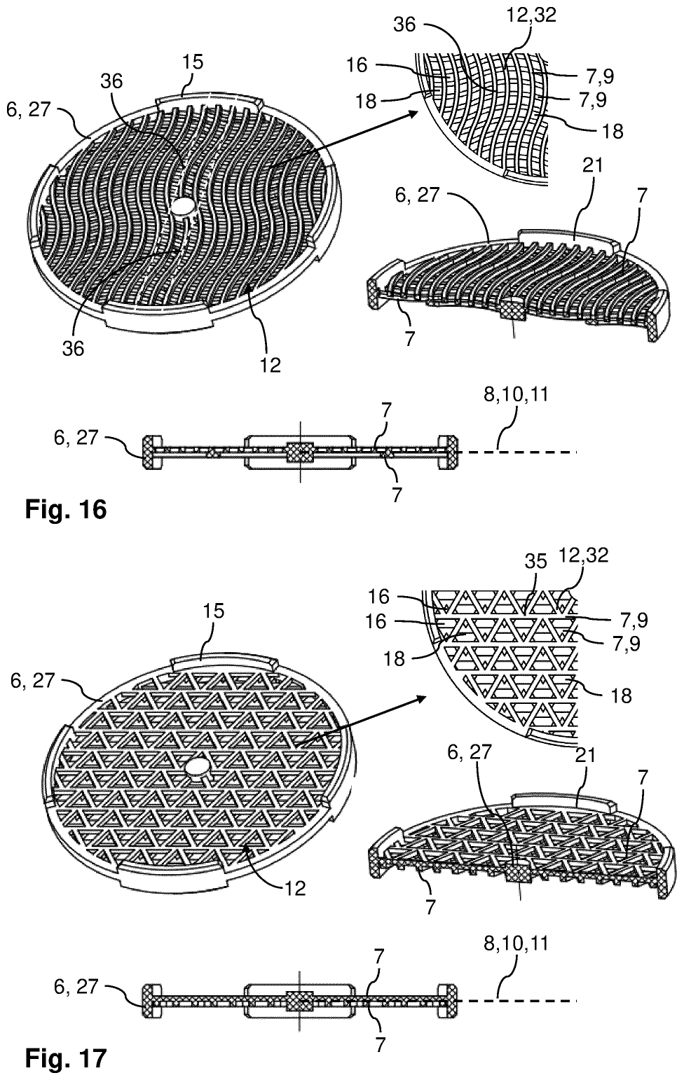

FIG. 16 shows a further possible design of an insert part 6 according to the invention, wherein here the webs 9 of the two web structures 7 each have an S-shaped course. In particular, the respective S-curve has two inflection points 36.

In the example in FIG. 15, the respective webs 9 of the respective web structure 7 each extend strictly along a specific direction, wherein these two directions of extension form an angle of φ=90°. Accordingly, the web structures 7 each form intermediate web spaces 18 in the form of elongated slots 26, some of which extend over the entire diameter of the web structure 7.

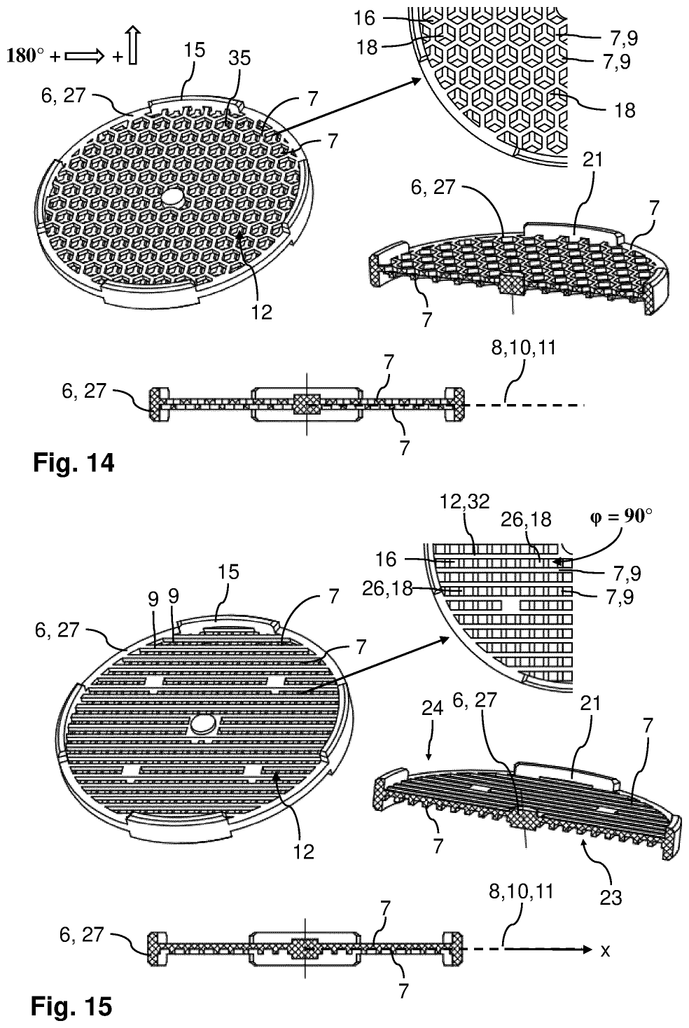

This is not the case in the example in FIG. 14. There, the webs 9 of the respective web structure 7 form hexagonal intermediate web spaces 18 in the form of honeycombs. In the example in FIG. 17, on the other hand, the intermediate web spaces 18 are in the form of triangular honeycombs. In both of these designs, a plurality of intermediate web spaces 18 are lined up along a secant in relation to a circumference of the web structure 7, wherein the intermediate web spaces 18 are separated from one another by the respective webs 9 of the web structure 7.

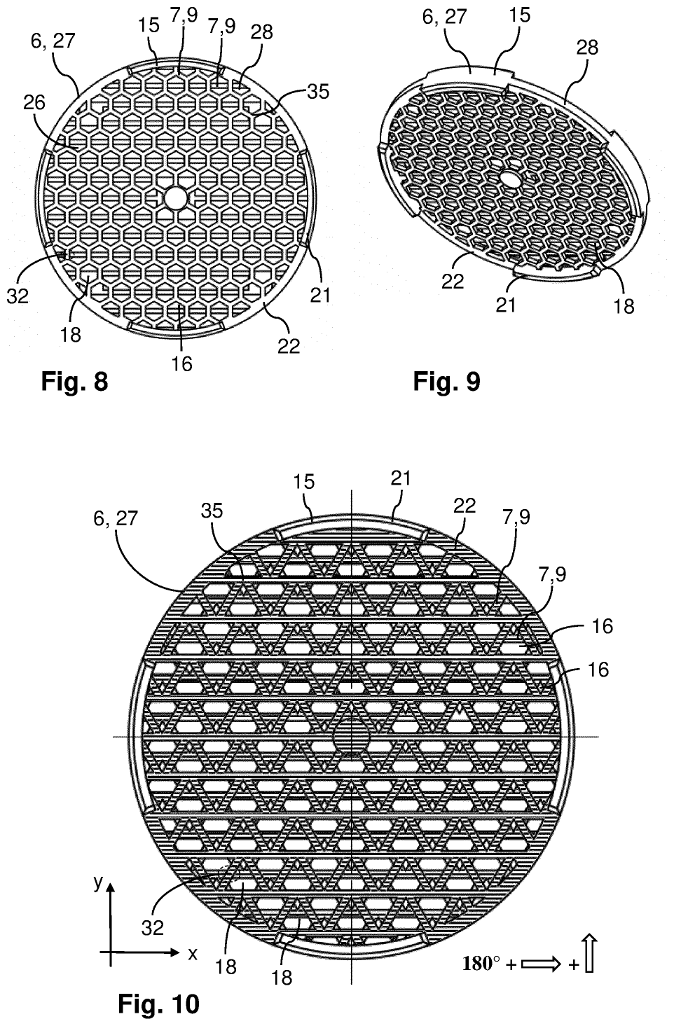

In the examples of FIGS. 6-9, one of the web structures 7 forms honeycomb-shaped free spaces 18 in each case, while the other of the two web structures 7 forms straight elongate slots 26. FIGS. 6-7 show a respective view from above of the upper web structure 7, which has straight webs 9. FIGS. 8 and 9, on the other hand, show views from below of the lower web structure 7, the webs 9 of which form a hexagonal grid.

As can be seen from the coordinate systems in FIGS. 4, 5 and 6, but also in FIGS. 22 and 23, the said mold parting plane 11 can be understood as an XY plane, wherein this plane divides the insert part 6 into the two web structures 7. In the examples in FIGS. 22 and 23, the two web structures 7 are each designed in a strictly symmetrical manner in relation to the mold parting plane 11, but are not congruent. For example, FIGS. 14 and 23, which show the same insert part 6, show that the intermediate web spaces 18 between the webs 9 form a large number of passage channels 16, which are aligned in the flow direction 31 (see FIG. 2) and are delimited by the respective webs 9. However, it can also be seen that the lower hexagonal grid, which is formed by the webs 9 of the lower web structure 7, divides precisely the intermediate web spaces 18 formed by the upper hexagonal web structure 7. Therefore, the passage area of the respective passage channels 16 is also smaller than the respective intermediate web space 18, which is formed by the upper web structure 7.

As can be clearly seen in FIGS. 22 and 23, in these designs the respective webs 9 of the two web structures 7 of the respective insert part 6 are designed in such a way that they form side surfaces 17 which extend coaxially to one another, namely along the flow direction 31. This direction can just correspond to the insertion direction 14 with which the respective insert part 6 is inserted into the receiving chamber 4 of the jet regulator 1 (cf. FIG. 2 and FIG. 3).

FIG. 5 shows further details of the stack arrangement 13 of a total of three insert parts 6, which can be inserted into the receiving space 4 of the jet regulator 1 of FIG. 3. The insert parts 6 are recognizably identical, i.e. they were manufactured using the same injection mold. It can also be seen that the respective upper web structures 7 of the three insert parts 6 are not aligned. The reason for this is that the three insert parts 6 are each rotated relative to each other by an angle α=30° around the insertion direction 14.

A similar situation is also illustrated again in FIG. 19, where the right-hand illustration shows a top view of the stack arrangement 13 and where the angle there is α=45°. Although each of the three insert parts 6 forms through channels 16 which have a square surface as cross-section, it can be clearly seen in FIG. 19 that, due to the relative rotation of the insert parts 6 to each other, the cross-section of the stack arrangement 13 through which water can flow unhindered is smaller and has a triangular cross-section.

As FIGS. 20 and 21 illustrate, differently designed insert parts 6 according to the invention can also be used in a stack arrangement 13, which form different web structures 7. For example, in FIG. 20, two insert parts 6 with hexagonal web structures 7 have been combined with an intermediate insert part 6 with slot-shaped web structures 7.

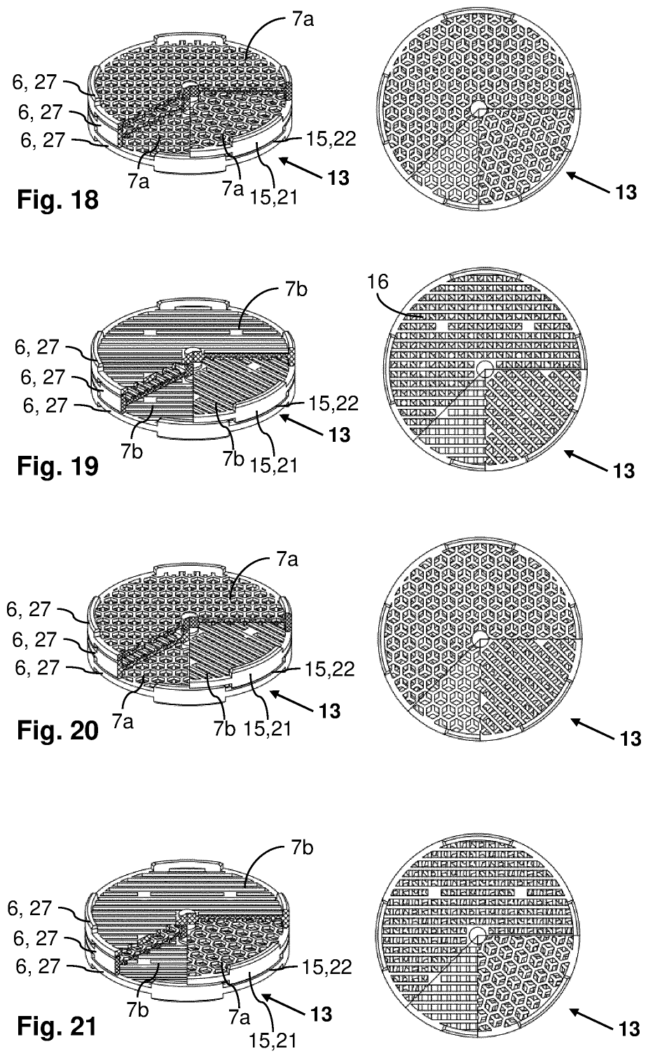

In all stack arrangements 13 of FIGS. 18-21, however, the passage channels 16, which are formed for example by the uppermost insert part 6, are at least partially covered by a web structure 7 of an underlying insert part 6 of the stack arrangement 13 (in relation to the insertion direction 14 or the direction of flow 31). FIG. 13 in particular makes it easy to understand that such concealment can be provided in particular by a branching point 35 of two webs, wherein these webs 9 then belong to one and the same web structure 7. However, it is also possible for the concealment to be formed precisely by contact points 12 or contact surfaces 32 which exist between two web structures of an insert part 6 of the stack arrangement 13. In relation to the entire stack arrangement 13, in the examples of FIGS. 13 and 18-21, the respective cross-sectional area occupied by a passage channel 16 of the uppermost insert part 6 cannot be completely flowed through by water in the axial direction. These designs achieve efficient homogenization of the water jet flowing through the stack arrangement 13.

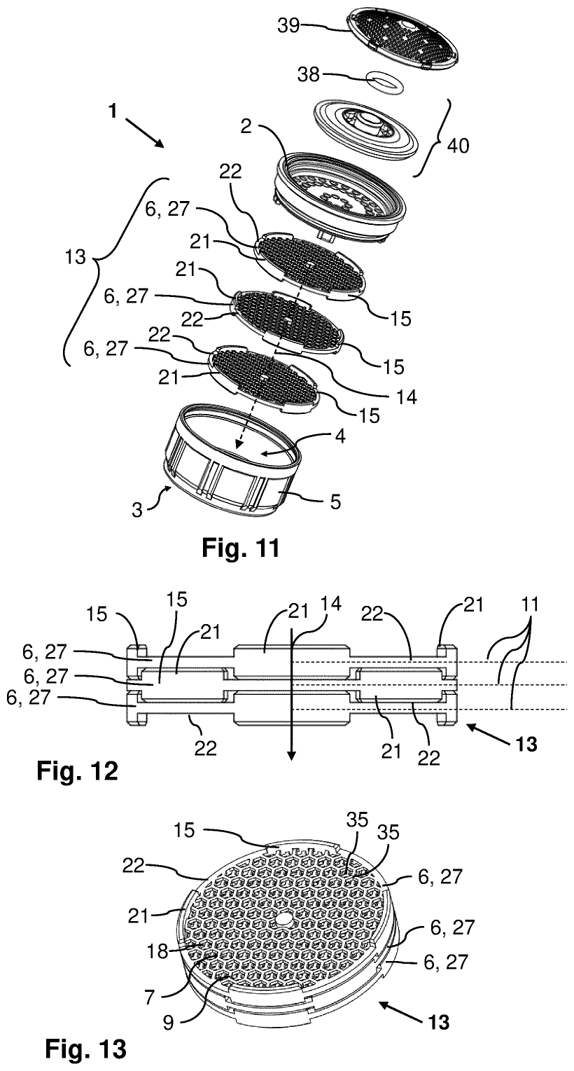

As can be clearly seen from FIGS. 18-21 and 11-13, the insert parts 6 are aligned with each other in the respective stack arrangement 13 by means of alignment halves 15. The alignment halves 15 interlock in the insertion direction 14 and thus specify the relative angle of rotation a that exists between two neighboring insert parts 6. The alignment aids 15 are formed in one piece with the respective web structure 7, namely in the form of axial and corresponding projections 21 and recesses 22.

As can be clearly seen in FIG. 5 or also in FIG. 12, the projections 21 formed on an insert part 6 of the upper or lower level 8 are aligned. The same applies to the recesses 22. This ensures that the alignment aids 15 are designed to be invariant in relation to a rotation of the insert part 6 by 180° around an x-axis, which lies in the respective mold parting plane 11 (=“flipping” of the insert part). For example, the uppermost insert part 6 in FIG. 12 has an upper and a lower alignment aid 15 that are aligned with each other in relation to the insertion direction 14.

In the example of FIG. 13 and FIG. 6, at least four alignment aids 15 are provided in the form of axial projections 21, which are evenly distributed along the circumference, whereby a relative angle of rotation of α=45° is specified. In the example in FIG. 5, on the other hand, at least six such alignment aids 15 are already provided, whereby a relative angle of rotation of α=30° is specified.

As the example in FIG. 5 shows, where the three insert parts 6 are each designed identically to one another, a respective lower axial profile 23 of the insert part 6 (cf. FIG. 4, FIG. 22 and FIG. 15) engages in a respective upper axial profile 24 of the insert part 6 below it. In FIG. 5, the respective projection 21 thus engages in the correspondingly designed recess 22 of the adjacent insert part 6. This engagement positions the two insert parts 6 relative to each other by the desired angle α. All of the insert parts 6 shown in FIG. 5 were produced using the same injection mold.

FIG. 15 clearly shows that the web structures 7 of the insert part 6 shown there are so symmetrical to one another that they can be transformed into one another by two symmetrical transformations. If, for example, the insert part 6 shown is flipped by rotating the upper web structure 7 (or the entire insert part 6) by 180° around an x-axis that lies in the mold parting plane 11, the two web structures 7 are exchanged in their respective positions. If the insert part 6 is then additionally rotated by an angle of φ=90° around the z-axis, which is perpendicular to the mold parting plane 11, the original state is restored because the respective webs 9 then extend in the original direction.

In the example in FIG. 14, a similar transformation would be possible because the insert part 6 there, or its web structures 7, are also symmetrical to each other. However, in order to transform the upper web structure 7 into the lower web structure 7 there, it is not necessary to rotate around the z-axis again after rotation by 180° around the x-axis, but the respective grid/web structure 7 must be moved along the y-axis, as can be seen from the upper right-hand representation in FIG. 14.

In the example in FIG. 10, the two web structures 7 are also symmetrical to each other in this way. However, as the block arrows indicate, after rotation by 180° around the x-axis, they must first be moved along the x-axis and then along the y-axis in order to transfer the respective web structure 7 into the neighboring web structure 7.

The technical advantage of such symmetrical designs of the web structures 7 can be seen in FIG. 5, where it can be seen that even if one of the insert parts 6 shown there is inadvertently inserted in the wrong orientation (i.e. rotated by 180° around the x-axis), the desired alignment of the web structures 7 can still be achieved, namely by simply rotating the insert part 6 by a necessary angle φ around the z-axis.

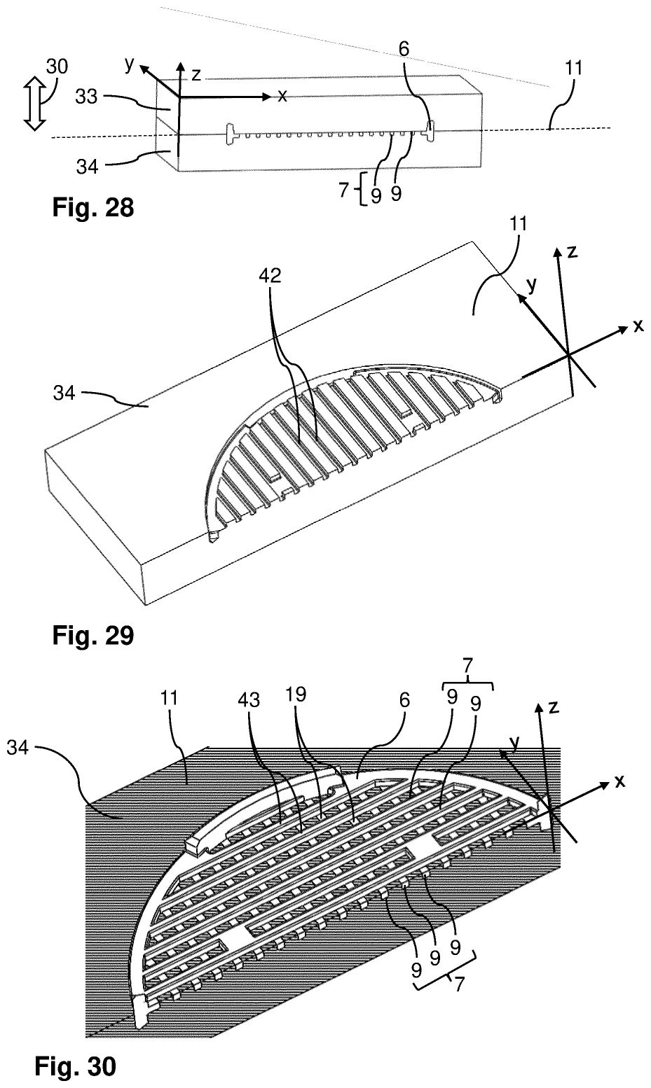

FIG. 24 illustrates the formation of molding fins at the edges of webs 9 of a web structure 7. A cross-section along the x-axis through the two web structures 7 of an insert part 6 according to the invention can be seen, wherein the respective webs 9 of the upper and lower web structure 7 clearly show no overlap in the z-direction and are thus separated from each other by the mold parting plane 11. It is known that molding fins 41 can form in the mold parting plane 11 when the injection molding material is pressed between the mold parts 33, 34 (cf. FIG. 28). The design of the mold parting plane 11 at the level of the transition between the two web structures 7 according to the invention has the advantage that the molding fins 41 are arranged at a uniform distance from the two outer sides 43 of the web structures 7. Thus, a position of these molding fins 41 is independent of the top-bottom orientation with which an insert part 6 is inserted or positioned for use. FIG. 24 also clearly shows that the two web structures (above and below the mold parting plane 11) each have cross-sections that do not face away from the mold parting plane 11. In the example shown, the cross-section is constant in the respective direction (+/−z-direction); however, it could also taper, for example, as it would still be possible to demold the insert part 6.

However, a glance at FIG. 32, which shows an insert part from the prior art, reveals that such a central formation of the molding fins 41 (as in FIG. 24) is not possible there (in FIG. 32), since the mold parts 33, 34 cannot engage behind the webs, since the web structures must remain demoldable.

FIG. 28 shows two mold parts 33 and 34 in the form of two mold halves of an injection mold, with which an insert part 6 according to the invention can be produced. For this purpose, the two mold halves are moved towards each other in the demolding direction 30 shown (=z-direction-cf. FIG. 29) in order to define a cavity and moved apart in the opposite direction in order to demold the injection-molded insert part 6. As can be seen in the sectional view, the insert part 6 extends from the mold parting plane 11, which separates the two mold parts 33 and 34 from each other as an xy plane (cf. FIG. 29), upwards and downwards into the respective mold halves 33, 34 or into the half-spaces in which these mold halves 33, 34 lie. The mold halves form corresponding recesses which, as a negative, each define the shape of the upper or lower half of the insert part 6.

As can be seen by comparing FIGS. 29 and 30, the lower web structure 7, which lies below the mold parting plane 11 in FIGS. 28 and 29, is defined exclusively by the lower mold half 34. This is because only the mold half 34 has a corresponding recess 42 in the form of grooves extending in the y-direction (cf. FIG. 29), which define the webs 9 of the lower web structure 7 of the insert part 6 extending in the y-direction (cf. FIG. 30). This can also be seen from the fact that the upper surfaces of the webs 9 of the lower web structure 7 are flush with the surface of the lower mold half 34, i.e. these surfaces lie in the xy plane illustrated in FIG. 29. During injection molding, these surfaces of the lower webs 9 are merely delimited by the surface of the upper mold half 33 lying in the mold parting plane 11, which is designed to be flat in these areas. In other words, it is possible with the mold parts 33, 34 to form one of the web structures 7 without the other web structure 7 by covering the respective mold part 33, 34 with a flat plate. In this (imaginary) example, the plate indicates the mold parting plane 11.

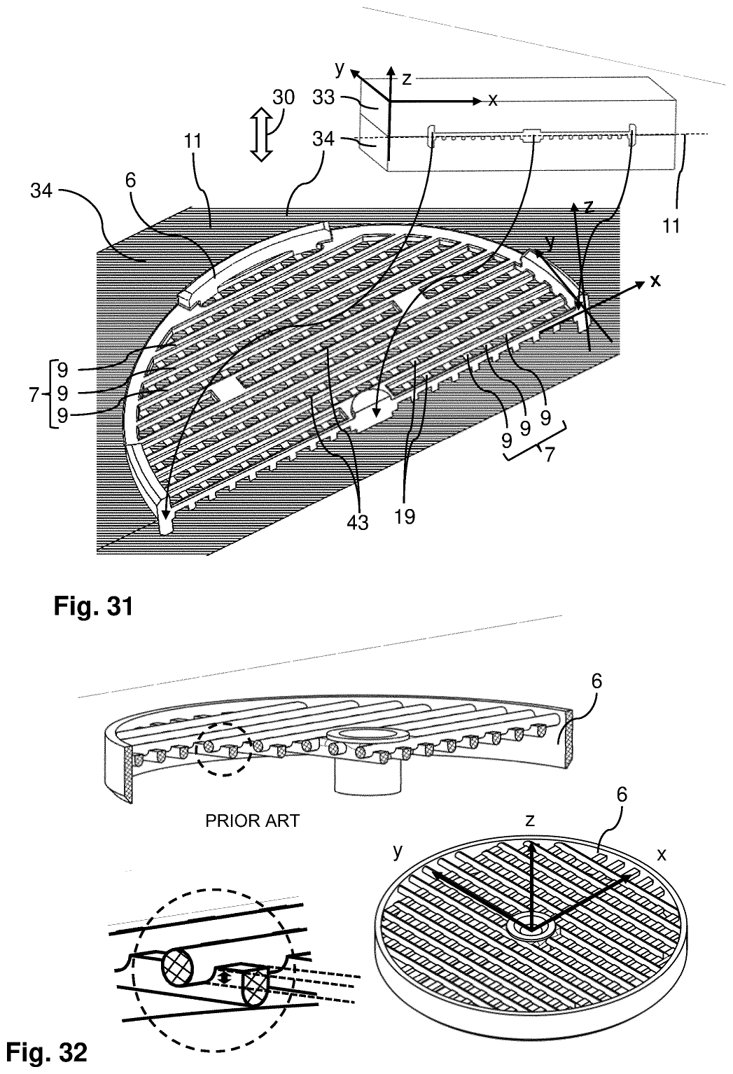

It can be seen from FIG. 31 (which shows the same situation as in FIG. 30, with only the section in the negative y-direction being shifted by about half a web distance) that the webs 9 of the upper web structure 7, which extend in the x-direction, all lie above the mold parting plane 11 and are thus defined exclusively by the upper mold half 33. Even if this is not illustrated, it is easy to imagine that the upper mold half 33 thus has corresponding grooves that extend in the x-direction in order to define the webs 9 of the upper web structure 7, in particular their exact position in the xy-plane. Only the lower web surfaces (not visible in FIG. 31) of the webs 9 of the upper web structure 7, which are aligned with the mold parting plane 11 (cf. also FIG. 22 or 23, for example), are delimited by the surface (aligned with the insert part) of the lower mold half 34. In other words, the webs 9 of the upper web structure 7 thus rest on the surface (hatched in FIG. 31) of the lower mold half 34, which lies in the mold parting plane 11. The (imaginary) contact surfaces 32 at which the webs 9 of the upper web structure 7 intersect with the webs 9 of the lower web structure 7 thus all lie in the mold parting plane 11. However, the upper web structure 7, or more precisely its webs 9, does not extend downwards beyond the mold parting plane 11 and thus does not project into the half-space occupied by the lower mold half 34.

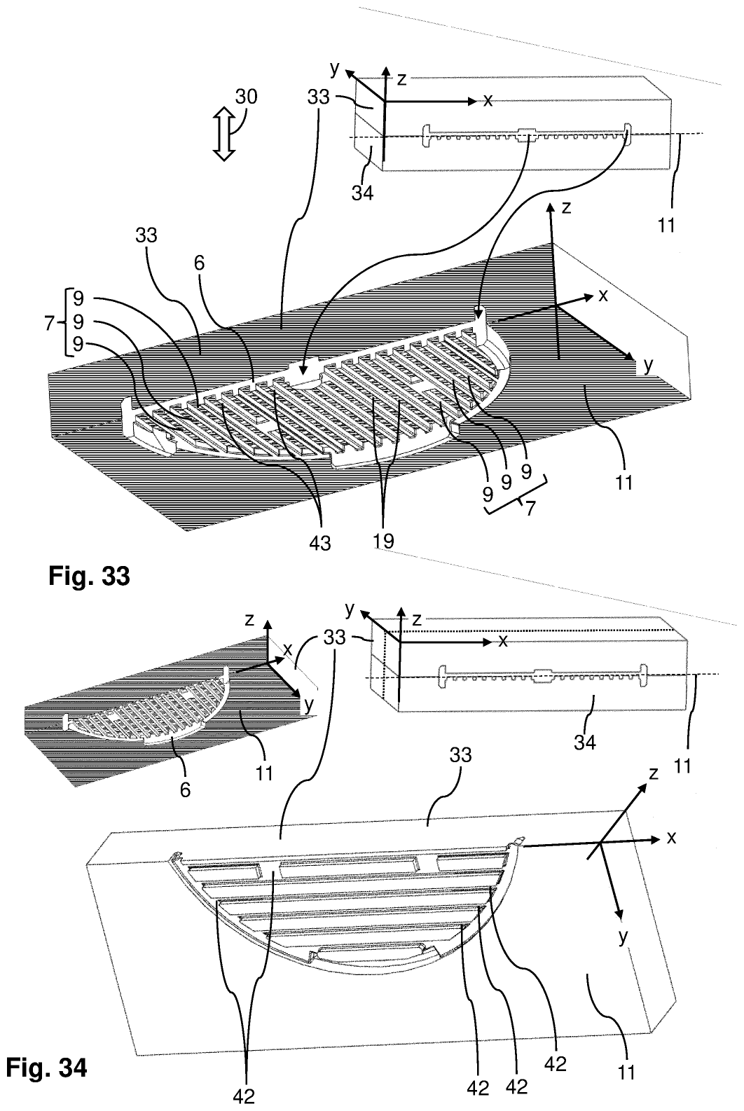

FIG. 33 shows an analogous situation to FIG. 31, wherein the upper mold half 33 is now illustrated, with the longitudinal section again extending through the center of the insert part 6 as in FIG. 31. FIG. 34 shows the same section through the upper mold half 33, but the longitudinal section extends off-center. FIG. 33 (as in FIG. 31) also shows the injection-molded insert part 6 after the two mold halves 33 and 34 have been separated and the lower mold half 34 has been removed.

In FIG. 34, however, only the upper mold half 34 is shown without insert part 6, so that the recesses 42 in the mold half 34, which define the shape of the webs 9 of the upper web structure 7 of the insert part 6, are visible. As can be seen, all these recesses 42 extend in the x-direction; recesses that could define the lower web structure 7, on the other hand, are missing. The smaller dark view in FIG. 34 also shows the upper mold half 33 intersected at the same decentralized position (cf. the dotted line in the view at the top right), but with the insert part 6 still in the mold half; the webs 9 of the lower web structure 7, which protrude from the upper mold half 33 in the negative z-direction and extend in the y-direction and are defined by the (not shown) lower mold half 34, are clearly visible in the smaller dark view.

In contrast, FIG. 32 shows an example of an insert part known from the prior art, more precisely from WO 2021 123065 A1, which forms a grating. As can be seen from the detailed view, in particular from the block arrow, the webs of the upper web structure project straight into the half-space occupied by the webs of the lower web structure. In other words, in this insert part, the two web structures (each of which has webs extending in the x and y directions) are not separated or separable from each other by a plane, but the web structures of the grating show an overlap (in the z direction). In FIG. 32, there is therefore no position of an xy separating plane that makes it possible to separate the two web structures from each other. In FIG. 31, on the other hand, this is precisely the xy plane, which coincides with the mold parting plane 11.

In summary, for the simplified manufacture of an insert part 6, which has two web structures 7, each of which forms a plurality of webs 9, it is proposed that the insert part 6 is manufactured by a molding process in such a way that the two web structures 7 touch each other in respective contact surfaces 32, but nevertheless remain separated from each other by a mold parting plane 11. This has the advantage that the respective outer contour of the webs 9 of the respective web structure 7 can be defined exclusively with a respective mold part 33/34, without an offset of the respective other mold part 34/33 having a negative effect on the shaping of the webs 9.

### LIST OF REFERENCE SIGNS

1 Jet regulator
2 Splitter unit
3 Outlet unit
4 Receiving chamber (arranged between 2 and 3)
5 Housing (surrounds 4)
6 Insert part (inserted in 4)
7 Web structure
8 (Imaginary) plane
9 Web (formed by 7)
10 Mold parting line
11 Mold parting plane
12 Contact point
13 Stack arrangement
14 (Axial) insertion direction
15 Alignment aid
16 Passage channel (formed by 7)
17 Web side surfaces (of 9)
18 Intermediate web space
19 Inward-facing web surfaces
20 Radial plane
21 Projection
22 Recess
23 Lower axial profile (of 6)
24 Upper axial profile (of 6)
25 Injection point
26 Slot
27 Injection molded part
28 Circumference
29 Cross connection (between 9)
30 Demolding direction
31 Flow direction
32 Contact surface
33 First mold part (in particular first mold half)
34 Second mold part (in particular second mold half)
35 Branching point (between 7)
36 Inflection point
37 Sanitary fitting
38 O-ring
39 Strainer attachment
40 Flow regulator
41 Molding fins
42 Recess (in 33/34 for the definition of 7)
43 Outside of 7

1. An insert part (6) for a jet regulator (1),
wherein water can flow through the insert part (6) along a flow direction (31), the insert part comprising:
two web structures (7) which are arranged in two superimposed planes (8) and which each have a plurality of webs (9), and
the two web structures (7) are each separated from one another by a mold parting plane (11).

2. The insert part (6) according to claim 1,
wherein the webs (9) of an upper one of the web structures (7) intersect with the webs (9) of a lower one of the web structures (7) at contact surfaces (32), and at least one of a) the webs (9) of a same one of the upper or lower web structure (7) branch at branching points (35), or b) at contact points (12) of the upper and lower web structures, (7) the respective webs (9) extend at a crossing angle β to one another.

3. The insert part (6) according to claim 2,
wherein at least one of a) the crossing angle β is dimensioned such that a surface area of a respective one of the contact surfaces (32) of the intersecting webs (9) in the mold parting plane (11) is at most three times a square of a width of the respective web (9), measured transversely to a running direction of the web (9) or b)
the crossing angle β: β>20°.

4. The insert part (6) according to claim 1,
wherein the at least two web structures (7) of the insert part (6)
are at least one of a) integrally connected or formed with each other or
b) manufactured as one injection-molded part (27),
using two mold parts (33, 44) which meet in the mold parting plane (11).

5. The insert part (6) according to claim 1,
wherein the insert part (6) has at least one of the web structures (7) whose webs (9) extend, at least partially, non-parallel to one another,
and therefore form branching points (35).

6. The insert part (6) according to claim 1,
wherein at least one of the two web structures (7) has the webs (9) which have an S-shaped course in said plane (8).

7. The insert part (6) according to claim 1,
wherein the two web structures (7) form different types of intermediate web spaces (18), including
elongated slots (26) in an upper one of the planes (8) and honeycomb-shaped free spaces (18) in a lower one of the planes (8).

8. The insert part (6) according to claim 1
wherein at least one of a) said mold parting plane (11) is an xy-plane and divides the insert part (6) into the two web structures (7), or
b) the two web structures (7) are formed symmetrically to one another in relation to the mold parting plane (11).

9. The insert part (6) according to claim 1, wherein the two web structures (7) are formed symmetrically with respect to one another such that the two web structures (7) are transferrable into each other by an imaginary rotation through 180° about an x-axis lying in the mold parting plane (11) and
by at least one of a) rotation through an angle q about a z-axis aligned perpendicular to the mold parting plane (11)
or
b) displacement along at least one of a y-axis lying in the mold parting plane (11) or the x-axis.

10. The insert part (6) according to claim 9, wherein the angle φ=360°/N is formed as an integer division of 360°.

11. The insert part (6) according to claim 1,
wherein at least one of a) the two planes (8) are each aligned radially or perpendicularly with respect to the flow direction (31), or
wherein b) all the web surfaces (19) of the webs (9) of each said web structure (7) aligned with the mold parting plane (11) lie in a respective radial plane (20) with respect to the flow direction (31).

12. The insert part (6) according to claim 1,
wherein at least one of the web structures (7) forms intermediate web spaces (18) shaped as honeycombs which are arranged between the webs (9), and
a plurality of such honeycomb-shaped intermediate web spaces (18) line up along a secant with respect to a circumference of the web structure (7) and are separated from one another by respective webs (9).

13. The insert part (6) according to claim 1,
wherein at least one of a) the respective webs (9) of the two web structures (7) each form lateral surfaces (17) which are aligned axially in an insertion direction (14) of the insert part (6) and which extend coaxially to one another,
or
passage channels (16) formed by intermediate web spaces (18) which exist between the webs (9), are aligned in the flow direction (31) and are delimited by the webs (9).

14. The insert part (6) according to claim 1,
wherein both of the web structures (7) each have cross-sections which point away in each case from the mold parting plane (11) and which do not increase in size.

15. A jet regulator (1), comprising:
a splitter unit (2) and an outlet unit (3), with a receiving chamber (4) formed therebetween, which is surrounded by a housing (5), at least one insert part (6) through which water is adapted to flow is inserted in the receiving chamber (4), and
the at least one insert part (6) includes two web structures (7) which are arranged in two superimposed planes (8) and which each have a plurality of webs (9), and the two web structures (7) are each separated from one another by a mold parting plane (11).

16. The jet regulator (1) according to claim 15,
wherein at least two of the insert parts (6) are arranged one above the other in a stack arrangement (13) in an axial insertion direction (14) in the receiving chamber (4), and at least one of
a) the at least two insert parts (6) are of the same or identical design to one another,
the at least two insert parts (6) are arranged rotated relative to each other by an angle α around the insertion direction (14), or
the receiving chamber (4), when the insert part (6) is inserted, is only transversable by passage channels (16) which are formed by the at least one insert part (6).

17. The jet regulator (1) according to claim 16,
wherein the two web structures (7) are formed symmetrically with respect to one another such that the two web structures (7) are transferrable into each other by an imaginary rotation through 180° about an x-axis lying in the mold parting plane (11) and by at least one of a) rotation through an angle φ about a z-axis aligned perpendicular to the mold parting plane (11) or b) displacement along at least one of a y-axis lying in the mold parting plane (11) or the x-axis, wherein the angle φ=360°/N is formed as an integer division of 360°,
and
$$α = φ / 2 ,$$

18. The jet regulator (1) according to claim 15,
wherein at least one of a) passage channels (16) aligned axially in the insertion direction (14), which are formed by one of the insert parts (6), are at least partially concealed with respect to the insertion direction (14) by the web structure (7) of an adjacent one of the insert parts (6) of the stack arrangement (13), or b) the passage channels (16) aligned axially in the insertion direction (14), which are formed by one of the insert parts (6), meet a contact point (12) of the two web structures (7) of an adjacent insert part (6) of the stack arrangement (13) in the stack arrangement (13).

19. The jet regulator (1) according to claim 15,
wherein the at least two insert parts (6) are aligned with each other with respect to a relative angle of rotation a about the insertion direction (14) by respective alignment aids (15) which engage with each other in the insertion direction (14).

20. The jet regulator (1) according to claim 19,
wherein the alignment aids include upper and lower alignment aids (15) that are formed on at least one of the insert parts (6), which are aligned with each other with respect to the insertion direction (14).

21. The jet regulator (1) according to claim 21,
wherein at least four of the alignment aids (15) are formed along a circumference of one of the at least two insert parts (6), which face axially in a same direction, and are distributed along a circumference.

22. The jet regulator (1) according to claim 15,
wherein each of the at least two insert parts (6) are arrangeable with an identical copy of itself in a compact stack arrangement (13), in which a lower axial profile (23) of the insert part (6) engages in an upper axial profile (24) of the insert part (6), and in said stack arrangement (13) the two identical insert parts (6) used are arranged rotated relative to one another by an angle α about an insertion direction (14).

23. The jet regulator (1) according to claim 15,
wherein the at least two insert parts (6) are at least one of all shaped identically to one another or have been manufactured with a same two injection mold halves in each case.

24. A method for manufacturing an insert part (6), the method comprising:
producing the insert part (6) as a cast part,
forming the insert part (6) with two web structures (7) which are arranged in two superimposed planes (8) and which each form a plurality of webs (9), and
using a first mold part (33) to form a first of the two web structures (7) during molding, and forming a second of the two web structures (7) only with a second mold part (34) during molding.
